(19) United States
(12) Patent Application Publication
(10) Pub. No.: US 2004/0018064 A1
(43) Pub. Date: Jan. 29, 2004

(54) Cutting tools

(76) Inventor: Chunghorng R. Liu, West Lafayette, IN (US)

Correspondence Address: Mr. Edward J. Timmer, Walnut Woods Centre, 5955 W. Main Street, Kalamazoo, MI, 49009, US

(21) Appl. No.: 10/389,676

(22) Filed: Mar. 14, 2003

Related U.S. Application Data
(60) Provisional application No. 60/364,121, filed on Mar. 15, 2002.

(51) Int. Cl. B23B 51/02

(52) U.S. Cl. 408/224

(57) ABSTRACT

A cutting tool for metallic or other non-wood materials is provided having a tool body with a leading cutting edge for making a first roughing cut on a workpiece and having a second trailing cutting edge so arranged on the same tool body relative to the first cutting edge that the second cutting edge makes a second finishing cut of the workpiece to provide final dimensions and surface integrity when the workpiece and the cutting tool are relatively moved to engage the cutting tool and workpiece. For a cutting tool comprising a drill, the leading cutting edge cuts a smaller diameter hole than the trailing cutting edge. For a cutting tool comprising a turning or milling tool, the leading cutting edge cuts a larger diameter surface on the workpiece than the trailingcutting edge. Also provided is a drill having a leading end provided with multiple cutting tips spaced laterally apart on the leading end in a manner to reduce deflection of the drill and produce a straighter hole in a workpiece.

This application claims the benefits of provisional application Serial No. 60/364,121 filed Mar. 15, 2002.

### CONTRACTUAL ORIGIN OF THE INVENTION

This invention was in part supported by funding from the National Science Foundation under Contract/Grant No. NSF 9900169 DMI. The Government may have certain rights in the invention.

### FIELD OF THE INVENTION

The present invention relates to cutting tools for machining a workpiece.

### BACKGROUND OF THE INVENTION

In cutting operations such as drilling, turning, milling and the like of metallic and other strong or hard, non-wood workpieces, it has been common practice to use one cutting tool to rough cut the workpiece followed by use of a second, different tool to finish the rough cut to final dimension. For example, the current state of the art to drill a hole in a workpiece involves initially rough drilling a first hole and then finishing the rough hole by internal grinding or by boring or by a second drilling operation using a different drill. Moreover, drill deflection during drilling can reduce the accuracy (e.g. straightness) of the drilled hole. Finishing of the drilled hole is needed to improve accuracy of the drilled hole and/or to improve the surface finish of the drilled surface. Improving surface integrity parameters, such as residual stress and micro-hardness distribution into the depth of the machined surface and surface finish imparted to the machined surface, are also desirable, especially for load carrying workpieces (components). However, there are no agreed guiding principles for accomplishing this in the prior art. Use of two different drills and two drilling operations to machine the hole increases machining time and cost. In the mean time, it does not always guarantee that all the requirements of the surface integrity of the finished surface are satisfactory.

### SUMMARY OF THE INVENTION

An embodiment of the invention provides a cutting tool for cutting a metallic or other strong or hard, non-wood workpiece wherein the cutting tool comprises a tool body with at least one leading cutting edge for making a first cut on a workpiece and with at least one trailing finish cutting edge so arranged on the tool body relative to the leading cutting edge that the second trailing cutting edge makes a second finish cut over at least a portion of the first cut when the workpiece and the cutting tool are relatively moved in cutting engagement pursuant to a method embodiment of the invention. A transition from the leading cutting edge to the trailing cutting edge can be stepwise, continuous (e.g. a gradual change in cutting edge dimension, such as cutting diameter), or any combination of the two.

For a cutting tool that comprises a drill, the second trailing cutting edge drills a hole with a diameter larger through at least a portion of an initial smaller diameter hole drilled by the leading cutting edge.

The difference between the two cutting diameters is to be determined by one or more of the following requirements, namely, achievement of an intentionally controlled residual stresses, micro-hardness variations, and/or selected surface finish to be imparted to the surface of the workpiece. The preferred range of the diameter difference is from about 0.006 inch to about 0.100 inch, which translates into the differences in depth of cut from about 0.003 inch to about 0.050 inch. Typically, the difference in depth of cut is 0.010 inch. An optimal value for the difference between the diameters can be determined by experimental tests to achieve the best levels of residual stresses, most consistent micro-structures, and/or best surface finish imparted to the workpiece surface.

Similar arrangements can be made for a milling tool for peripheral or face milling. For a cutting tool that comprises a turning (or milling) tool, the second trailing cutting edge cuts a smaller diameter outer surface over at least a portion of an initial larger diameter outer surface cut by the first leading cutting edge on the workpiece. The difference of the two cutting diameters is determined by the same methods and factors mentioned for drill design such that the trailing cutting edge has a minimum depth of cut of about 0.003 inches and a maximum depth of cut of about 0.050 inches, the depth of cut typically being 0.010 inches.

The typical tool nose radius of the trailing cutting edge is larger than that of the leading cutting edge. The tool rake angle of the trailing edge typically is more positive (or less negative) compared with that of the leading cutting edge. The transition from the leading to the trailing cutting edge can be gradually leading to the second larger diameter of the drill, or it can be protruded as a step and followed by a smaller diameter section following the trailing cutting edge in the drill.

In an illustrative embodiment of the invention, the cutting tool comprises an elongated drill having at least one leading cutting edge proximate a leading end of the drill for drilling a relatively small diameter rough hole in a workpiece and a trailing cutting edge disposed in axially trailing relation to the first leading cutting edge so as to drill a larger diameter finish hole in the workpiece in a single stroke or pass of the drill relative to the workpiece. The leading cutting edge can be machined on the drill body or provided on at least one of a leading cutting insert fastened on the drill body. The trailing cutting edge likewise can be machined on the drill body or provided on at least one of a trailing cutting insert fastened on the drill body.

Another embodiment of the invention involves a drill having a leading end provided with multiple cutting tips or inserts spaced laterally apart on the leading end in a manner to reduce deflection of the drill and produce a straighter hole in a workpiece. In an illustrative embodiment of the invention, first and second truncated conical cutting tips are provided and spaced laterally apart on the leading end of the drill to produce a straighter drilled hole. All cutting edge design can follow conventional methodology.

Features and advantages of the present invention will become more apparent from the following detailed description taken in conjunction with the following drawings.

### DESCRIPTION OF THE DRAWINGS

FIG. 1 is a side elevation of a fluted drill in accordance with an embodiment of the invention having leading cutting edges with a first cutting diameter d₁ and having axially trailing second cutting edges on the same drill body with a second cutting diameter d₂ larger than the first cutting diameter.

FIG. 2 is a side elevation of a turning tool in accordance with still another embodiment of the invention having a leading cutting edge for cutting the workpiece to a first diameter d1 and having a second trailing cutting edge on the same turning tool body for cutting the workpiece to a second cutting diameter d2 smaller than the first cutting diameter in a single turning stroke.

FIG. 3 is a side elevation of a fluted drill in accordance with a still further embodiment of the invention having a leading end provided with multiple integral cutting tips (two shown) spaced laterally apart on the leading end in a manner to reduce deflection of the drill and produce a straighter hole in a workpiece.

FIG. 3A is an end view of the drill of FIG. 3 showing the cutting tips.

FIG. 4 is a side elevation of a fluted drill in accordance with a still additional embodiment of the invention having a leading end provided with multiple cutting insert tips (two shown) spaced laterally apart on the leading end in a manner to reduce deflection of the drill and produce a straighter hole in a workpiece.

FIG. 5 is a side elevation of a fluted drill in accordance with another embodiment of the invention embodying features of the embodiments of FIGS. 1-4.

FIG. 6 is a partial side elevation of a fluted drill in accordance with a still additional embodiment of the invention having a leading end provided with two integral leading integral cutting tips spaced laterally apart on the leading end and a trailing integral cutting tip between the leading cutting tips on the leading end of the drill to reduce deflection of the drill and produce a straighter hole in a workpiece.

### DESCRIPTION OF THE INVENTION

In an illustrative embodiment, the present invention provides a cutting tool and method for making an initial rough cut on a workpiece followed by a second finish cut using leading and trailing cutting edges on the same tool and using a single relative movement of the cutting tool and workpiece (e.g. a single cutting stroke or pass of the cutting tool relative to the workpiece). The invention can be practiced to machine a workpiece by drilling, turning, milling, and other cutting operations where an initial rough cut is made followed by a subsequent finish cut over at least a portion of the initial rough cut of the workpeice. The cutting tool is especially useful and advantageous in machining a workpiece comprising a metallic material such as a metal or alloy (e.g. carbon steel, bearing steel, alloy steel, high speed steel and other metallic material), composite material, or other strong and/or hard material other than wood. The leading and trailing cutting edges can be on the same tool, the same tool holder but on different tools, or each on a separate tool holder.

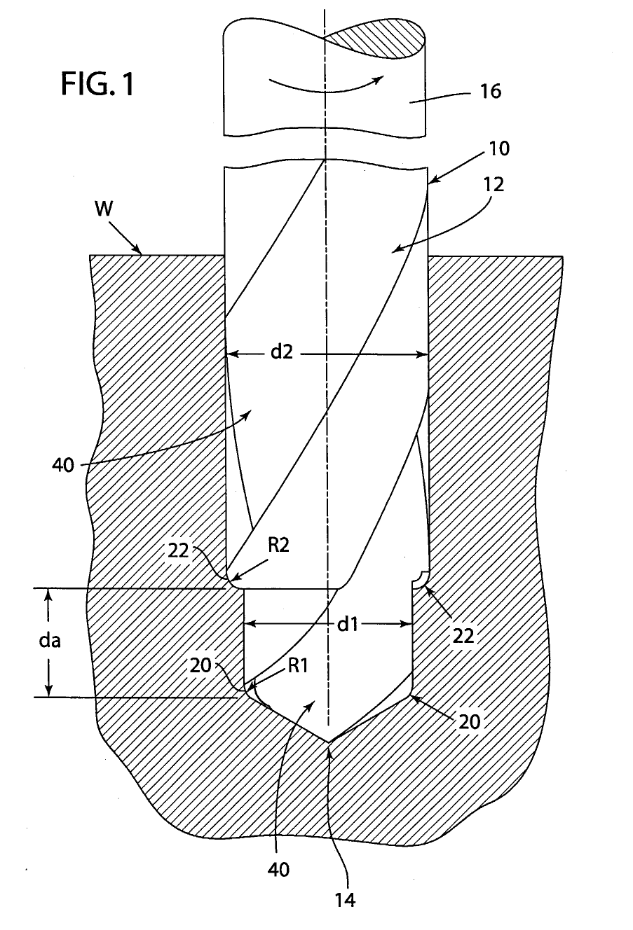

Referring to FIG. 1, a cutting tool pursuant to an illustrative embodiment of the invention is shown as a drill 10. The drill 10 comprises an elongated drill (tool) body 12 which can be made of any suitable material, such as for example high speed steel. The cutting edges of the drill can be coated with a hard coating, such a titanium nitride or other like hard coating, to increase the service life of the drill.

The drill body 12 includes a leading end 14 that initially contacts the workpiece W and a shank end 16 shaped to be held in a conventional chuck of a drilling machine or hand drill as is well known.

Pursuant to the illustrative embodiment of the invention, the drill body 12 includes leading cutting edges 20 for making a first cut to create a smaller diameter (first drilled hole) in the workpiece W and trailing finish cutting edges 22 so arranged on the tool body relative to the leading cutting edges 20 that the second trailing cutting edges 22 make a second finish cut (second drilled hole) through a length of the first hole surface that requires finishing (e.g. at least a portion of the length the first hole) when the drill 10 is moved in relative cutting engagement with the workpiece W.

The leading cutting edges 20 typically start at the leading end 14 and extend in a spiral path toward the shank end 16. The leading cutting edges 20 can terminate at the leading end 14 slightly laterally spaced apart to form a chisel at the leading end or at a point at the leading end 14 as shown.

The trailing finish cutting edges 22 typically each have a tool nose radius R2 larger than the tool nose radius R1 of the leading cutting edges 20 and start an axial trailing distance da from the leading cutting edges 20 and extend in a spiral path toward the shank end 16. The cutting edges 20, 22 are located on the edges of respective spiral flutes (grooves) 40 adjacent thereto that carry chips cut from the workpiece toward the shank end 16 in conventional manner.

The outer diameter d1 of leading cutting edge 20 drills an initial hole of that diameter in the workpiece W when the drill 10 is relatively advanced into the workpiece. The larger diameter d2 of the trailing finish cutting edge 22 drills a finish hole of that larger diameter in the workpiece W through at least a portion of the first drilled hole when the relative advance of the drill 10 into the workpiece is continued as part of the single drilling stroke of the drill 10 into the workpiece. In this way, the second cutting edge 22 drills a larger diameter, finish hole through at least a portion of the initial smaller diameter, rough hole drilled by the leading cutting edge in a single drilling stroke or pass of the drill 10 without the need to change to a grinding tool or to a different drill to drill the second larger diameter finish hole in the workpiece W. The holes drilled by cutting edges 20, 22 can extend through the entire thickness of the workpiece or one or both of the initial and finish holes can extend only through a length requiring a finish cut partway through the thickness of the workpeice W, depending upon the extent of the selected drilling stroke or pass relative to the workpeice.

The preferred range of the diameter difference is from about 0.006 inch to about 0.100 inch, which translates into the differences in depth of cut from about 0.003 inch to about 0.050 inch. Typically, the difference in depth of cut is 0.010 inch. An optimal value for the difference between the diameters can be determined by experimental tests to achieve the best levels of residual stresses, most consistent microstructures, and/or best surface finish imparted to the workpiece surface. In one embodiment of the invention, the diameter difference is controlled to provide optimum levels and distribution of residual stresses into the depth of the machined surface, most consistent micro-structures and thus consistent micro-hardness into the depth of the machined surface, and/or the optimal surface finish imparted to the metallic or other non-wood workpiece.

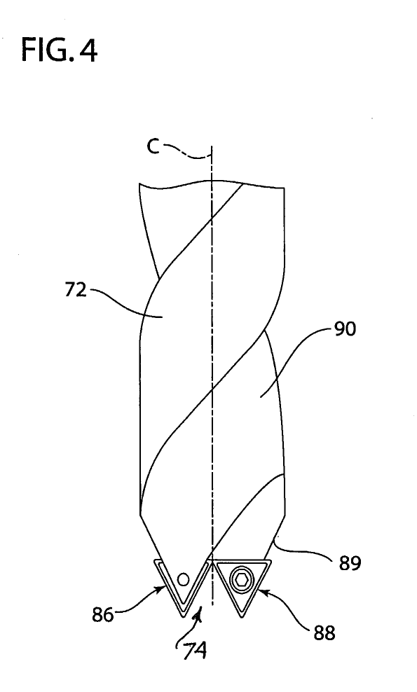

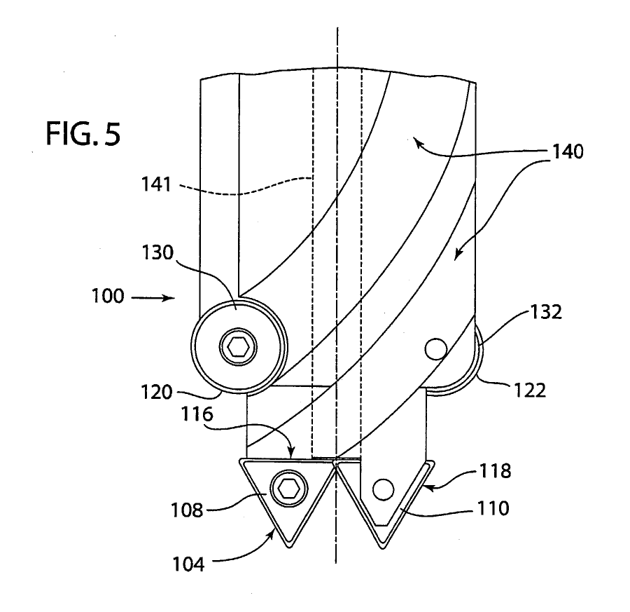

The drill 10 of FIG. 1 can be made by modifying the conventional method of making a drill. In particular, a starting solid rod having two diameters of d1 and d2 can be used. The drill 10 can be made with the cutting edges and flutes shown in FIG. 1 by applying to such two-diameter starting rod a similar procedure that is used to make a conventional drill. Alternately, the drill 10 of FIG. 1 can be made from an already-made conventional drill by first grinding or otherwise machining the original diameter d2 to reduce its diameter to the smaller diameter d1 proximate the drill leading end. Then, the trailing cutting edge 22 (and/or corresponding flutes 40) on the drill body 10 can be ground or machined so that typically they have a larger tool nose radius and possibly smaller negative (or larger positive) rake angles than those of the leading cutting edge 20 producible by grinding or machining. Alternately, one or more of the leading cutting edges 20 can be provided by one or more cutting inserts fastened on the drill body 10 in a manner described and shown below with respect to FIGS. 4 and 5. Similarly, one or more of the trailing cutting edge surfaces 22 can be provided by one or more trailing cutting inserts fastened on the drill body 10 in a manner shown schematically in FIG. 5. Such cutting inserts can comprise metal carbide inserts, silicon nitride inserts, CBN inserts, or other ceramic cutting inserts, or any other suitable cutting inserts. The cutting inserts can be fastened to the drill body metallurgically (e.g. by brazing) and/or mechanically using fasteners as is known.

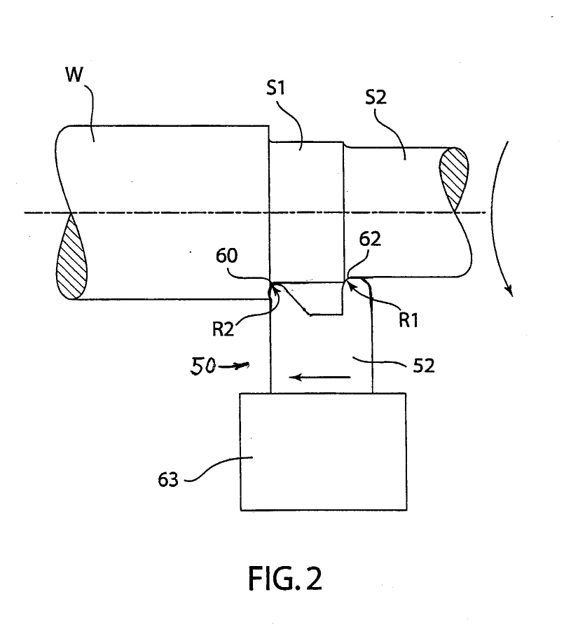

Referring to FIG. 2, a turning tool 50 is shown as another illustrative embodiment of the invention to cut a cylindrical surface on a rotating workpiece W. The tool body 52 includes at least one leading cutting edge 60 for making a first rough cut in the workpiece W and at least one trailing finish cutting edge 62 so arranged on the tool body 52 relative to the leading cutting edge 60 that the second trailing cutting edge 62 makes a second finish cut through at least a portion of the first cut when the turning tool 50 is moved in relative cutting engagement with the rotating workpiece W. In particular, the leading cutting edge 60 first cuts a large diameter outer surface S1 on the workpiece W as the cutting edge 60 leads the trailing cutting edge 62 in cutting engagement with the workpiece when the turning tool 50 and the workpiece are relatively translated in a single stroke or pass along the length of the workpiece. The trailing cutting edge 62 trails the leading cutting edge 60 to then cut a smaller diameter outer finish surface S2 on the first surface S1 as the turning tool and the workpiece continue to be relatively translated in a single stroke or pass along the length of the workpiece. The tool nose radius of the trailing cutting edge 62 is typically larger than that of the leading edge 60 and the rake angle of cutting edge 62 is typically more positive (or less negative) than that of cutting edge 60. Typically as is known, the turning tool 50 is mounted on a movable tool holder 63 of a turning machine to move in a single stroke or pass along the length of the workpiece as the workpiece rotates. The leading and trailing cutting edges 60 and 62 respectively can be designed into one single tool or, alternately, as two separate entities such as two inserts held together side by side so that rough and finish cuts can be performed at one single pass by translation of the tool relative to the workpiece without changing the tool.

For a cutting tool that comprises a turning (or milling) tool, the trailing cutting edge cuts a smaller diameter outer surface over at least a portion of an initial larger diameter outer surface cut by the leading cutting edge on the workpiece. The difference between the two diameters is determined by the same methods and factors mentioned above for drill design to achieve optimal levels and distribution of residual stresses into the machined surface, most consistent micro-structures for consistent micro-hardness into the machined surface, and/or the optimal surface finish to be imparted to the metallic or other non-wood workpiece. For example, the minimum depth of cut of the trailing cutting edge 62 can be about 0.003 inches and the maximum depth of cut of the trailing cutting edge can be about 0.050 inches and typically 0.010 inches for machining a steel or other metallic workpiece.

The configuration of the cutting edges 60, 62 shown for the turning tool 50 can likewise be imparted to a milling tool (not shown) to first cut a rough surface of relatively large thickness followed by cutting of a finish surface of relatively smaller thickness (diameter) on a workpiece in a single stroke or pass of the milling tool relative to the workpiece.

In lieu of being machined (or otherwise formed) on the tool body 52, the leading cutting edge 60 and trailing cutting edge 62 can be provided by respective cutting inserts (not shown but similar to cutting inserts described below with respect to FIGS. 4 and 5) fastened on the tool body 52.

Another embodiment of the invention involves a drill having a leading end provided with multiple cutting tips spaced laterally apart on the leading end in a manner to reduce sideways deflection of the drill during hole drilling and produce a straighter hole in a workpiece.

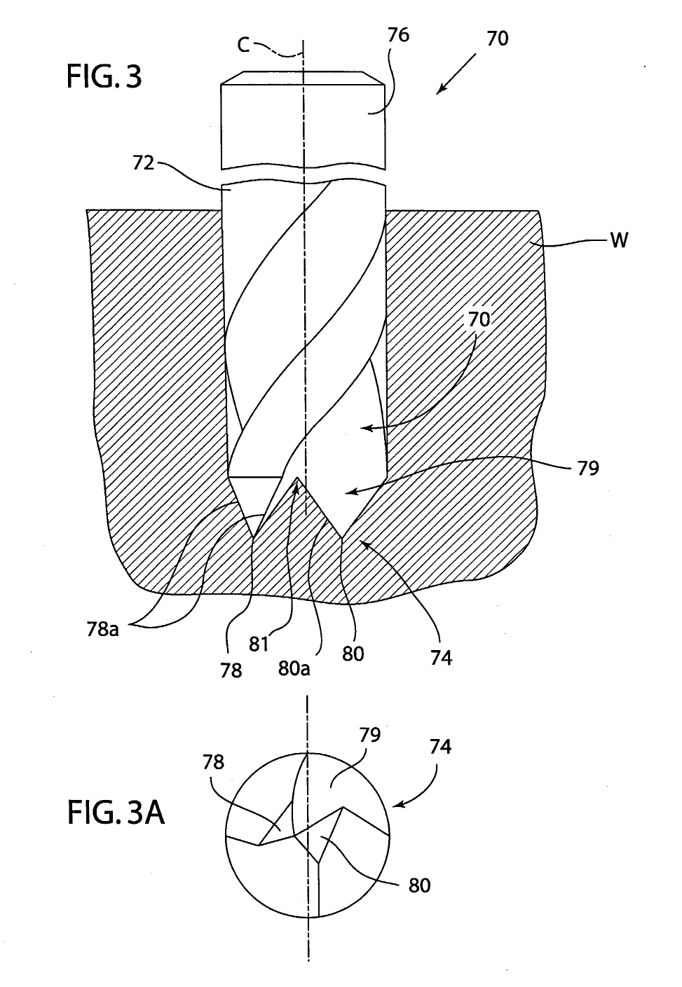

FIGS. 3 and 3A illustrate a drill 70 pursuant to another embodiment of the invention where the drill 70 includes an elongated drill body 72 having a leading end 74 that initially contacts the workpiece and a shank end 76 adapted to be held in a conventional chuck of a drilling machine or hand drill as is well known. The leading end 74 includes first and second cutting tips 78, 80 having cutting edges 78a, 80a. An undercut region 81 is provided between the cutting tips 78, 80. Each cutting tip 78, 80 includes cutting edge surfaces 78a, 80a and can be communicated to a respective spiral flute 79 provided on the drill body 72 to carry chips cut from the workpiece toward the shank end 76. Alternately, three flutes can be provided on the drill body 72 to this end. Still further, an optional internal axial passage can be provided along the length of the drill body 72 to carry chips and a machined core material toward the shank end 76 as shown for example in FIG. 4. Each cutting tip 78, 80 can comprise a machined truncated conical shaped surface.

The first and second cutting tips 78, 80 can be formed and/or machined integrally on the leading end 74 to be spaced laterally apart thereon and offset relative to the vertical centerline C of the drill body 72 such that the first and second cutting surfaces 78, 80 are spaced different lateral distances from vertical centerline C of the drill body as shown in FIG. 3.

In a method embodiment to drill a hole in a workpiece, the multiple cutting tips 78, 80 on the leading end 74 of the rotating drill engage the workpiece during drilling, and their inclusion on the leading end 74 will reduce sideways deflection of the drill body 72 during drilling and result in a straighter drilled hole being more consistently produced.

Although the first and second cutting tips 78, 80 are described as being machined or formed integrally on the leading end 74 of the drill body 72, they alternately can be provided on respective cutting inserts 86, 88 fastened on the leading end 74 of the drill body as shown in FIG. 4. The cutting edge surfaces of the cutting inserts 86, 88 are disposed in an axial leading location relative to cutting surfaces 89 and flutes 90 machined on the drill body 72. The cutting inserts 86, 88 can comprise metal carbide cutting inserts, silicon nitride inserts, CBN inserts, or other ceramic cutting inserts, or any other suitable cutting inserts. The cutting inserts 86, 88 can be fastened to the leading end 74 of the drill body metallurgically (e.g. by brazing) and/or mechanically using fasteners.

Referring to FIG. 5, a fluted drill 100 is shown embodying the features of FIGS. 1 and 3-4. For example, the drill 100 includes a leading end 104 having one or more leading cutting tips 108, 110 provided on respective one or more leading cutting inserts 116, 118 fastened on the leading end 104 to reduce sideways deflection of the elongated drill body as described with respect to FIGS. 3 and 4. The drill also includes one or more trailing cutting edges 120, 122 provided on one or more cutting inserts 130, 132 fastened on the drill body an axial trailing distance from the leading cutting tips 108, 110 to drill a larger diameter (e.g. diameter d2) finish hole through at least a portion of the smaller diameter (e.g. diameter d1) initial rough hole drilled by the leading cutting tips 108, 110 in a single stroke or pass of the drill relative to the workpiece as described with respect to FIG. 1. The drill includes flutes 140 for the chips cut from the workpiece as described above. An optional axial passage or hole 141 extending along the vertical centerline of the drill also may be provided to this end.

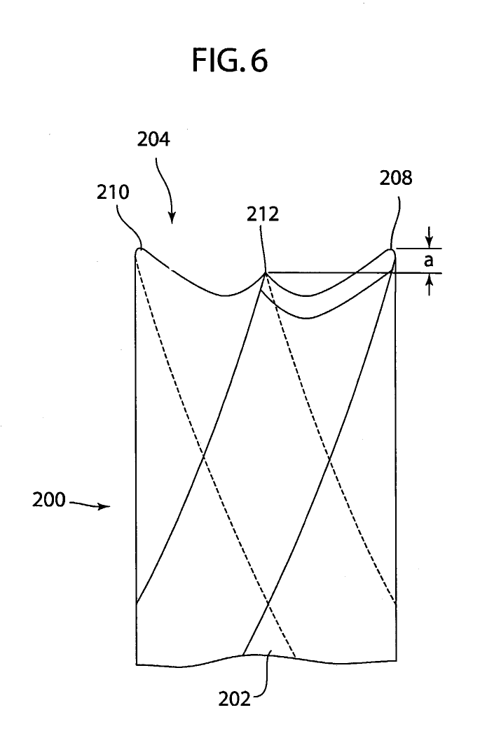

FIG. 6 illlustrates a partial side elevation of a fluted drill 200 in accordance with still another embodiment of the invention having a leading end 204 provided with first and second integral leading cutting tips 208, 210 spaced laterally apart on the leading end and a center trailing cutting tip 212 disposed between the leading cutting tips 208, 210 on the leading end to reduce deflection of the drill and produce a straighter hole in a workpiece. The cutting tips 208, 210 are disposed at the lateral sides of the leading end 204, while the trailing cutting tip 212 is disposed at the center, or in between tips 208 and 210 of the leading end 204 generally on the vertical centerline of the drill body 202. The trailing cutting tip 212 is shown axially spaced distance “a” in the trailing axial direction of the elongated drill body 202 from the cutting tip 208 as shown in FIG. 6. In lieu of integrally formed cutting tips, the tips 208, 210, 212 may be provided on cutting tip inserts fastened on the drill body 202 as described above with respect to FIGS. 4 and 5. In drilling a hole in a workpiece, the leading cutting tips 208, 210 engage the workpieces ahead of the trailing cutting tip 212. The spiral flutes shown carry chips cut from the workpiece toward a shank end (not shown) of the drill 200.

Although the invention has been described with respect to certain embodiments thereof, those skilled in the art will that changes and modifications can be made thereto within the scope of the invention as set forth in the appended claims.

I claim:

1. A cutting tool having a tool body with at least one leading cutting edge for making a first cut on a workpiece and having at least one trailing finish cutting edge so arranged on the tool body relative to said at least one leading cutting edge that the second cutting edge makes a second finish cut over at least a portion of the first cut on the workpiece when the workpiece and the cutting tool are relatively moved in cutting engagement.

2. The cutting tool of claim 1 wherein the second cutting edge has a larger tool edge nose radius than that of the first cutting edge.

3. The cutting tool of claim 1 comprising a drill wherein said at least one trailing cutting edge drills a larger diameter hole through at least a portion of an initial smaller diameter drilled by said at least one leading cutting edge in the workpiece.

4. The cutting tool of claim 1 comprising a turning or milling tool wherein said at least one trailing cutting edge cuts a smaller diameter surface over at least a portion of an initial larger diameter surface cut by said at least one leading cutting surface on the workpiece.

5. The cutting tool of claim 1 wherein said at least one leading cutting edge is machined on the tool body.

6. The cutting tool of claim 1 wherein said at least one trailing cutting edge is machined on the tool body.

7. The cutting tool of claim 1 wherein said at least one leading cutting edge and/or said at least one trailing cutting edge comprises a cutting insert disposed on the tool body.

8. The cutting tool of claim 1 wherein said at least one trailing cutting edge has a cutting dimension selected different from that of said at least one leading cutting edge and effective to impart at least one of a controlled residual stress, controlled hardness, and a controlled surface finish to the machined workpiece surface.

9. An elongated drill having at least one leading cutting edge proximate a leading end of the drill for drilling a relatively small diameter hole in a workpiece and a trailing cutting edge axially disposed from said at least one leading cutting surface on the drill body so as to drill a larger diameter hole through at least a portion of an initial smaller diameter drilled by said at least one leading cutting edge.

10. The drill of claim 9 wherein said at least one leading cutting edge is machined on the drill body.

11. The drill of claim 9 wherein said at least one trailing cutting edge is machined on the drill body.

12. The drill of claim 9 wherein said at least one leading cutting edge and/or said at least one trailing cutting edge comprises a cutting insert disposed on the drill body.

13. The drill of claim 9 wherein said at least one trailing cutting edge has a cutting diameter selected different from that of said at least one leading cutting edge effective to impart at least one of a controlled residual stress, controlled hardness, and controlled surface finish to the surface of the hole.

14. A drill having a leading end provided with multiple cutting tips spaced laterally apart on the leading end in a manner to reduce deflection of the drill and produce a straighter hole in a workpiece.

15. The drill of claim 14 having an axial passage in the form of a hole extending from the leading end to receive chips cut from the workpiece.

16. The drill of claim 14 wherein the first and second cutting tips are spaced different distances from a centerline of the drill body.

17. The drill of claim 14 wherein the multiple cutting tips are machined on the leading end of the drill body.

18. The drill of claim 14 wherein the multiple cutting tips comprise multiple cutting inserts disposed on the leading end of the drill body.

19. The drill of claim 14 wherein the first and second cutting tips each comprises a truncated conical surface.

20. The drill of claim 14 including a leading cutting tip and a trailing cutting tip spaced axially in a trailing axial direction on the leading end.

21. The drill of claim 20 wherein the cutting tips comprise cutting inserts disposed on the leading end of the drill body.

22. The drill of claim 20 wherein the cutting tips comprise multiple cutting inserts disposed on the leading end of the drill body.

23. A method of machining a workpiece comprising a metallic material or other non-wood material, comprising relatively moving a cutting tool and the workpiece to make an initial cut on the workpiece using a leading cutting edge of the cutting tool and to make a second finish cut over the at least a portion of the first cut using a trailing cutting edge in a single relative movement between one or more cutting tools and the workpiece.

24. The method of claim 23 wherein the cutting tool is a drill and wherein the trailing cutting edge drills a larger diameter hole through at least a portion of an initial smaller diameter drilled by the leading cutting edge in the workpiece.

25. The method of claim 23 wherein the cutting tool is a turning or milling tool and wherein the trailing cutting edge cuts a smaller diameter surface over at least a portion of an initial larger diameter surface cut by the leading cutting edge on the workpiece.

26. In a method of drilling a hole in a workpiece, the improvement comprising engaging a multiple cutting tips on a leading end of a rotating drill with the workpiece to drill the hole.

27. The method of claim 26 wherein the multiple leading cutting tips engage the workpiece followed by engagement of a trailing cutting tip also disposed on the leading end of the drill.

28. A method of machining a workpiece using the tool of claim 1.
